(19) United States
(12) Patent Application Publication
(10) Pub. No.: US 2023/0102268 A1
(43) Pub. Date: Mar. 30, 2023

(54) SYSTEMS AND METHODS FOR CONTROLLING AN ENVIRONMENT BASED ON A CHANGE OF ENVIRONMENTAL CONTEXT

(71) Applicant: EVEY INNOVATION INC., Montreal (CA)

(72) Inventors: Keaven MARTIN, Montreal (CA); Shan MEUNIER-BERNARD, Montreal (CA)

(73) Assignee: EVEY INNOVATION INC., Montreal, QC (CA)

(21) Appl. No.: 17/908,970

(22) PCT Filed: Mar. 2, 2021
(86) PCT No.: PCT/CA2021/050272

§ 371 Date: Sep. 2, 2022

(30) Foreign Application Priority Data
Mar. 4, 2020 (CA) 3,074,385

(51) Int. Cl. F24F 11/64; F24F 11/56

(52) U.S. Cl. CPC F24F 11/64; F24F 11/56; F24F 2120/10

(57) ABSTRACT

The present disclosure provides systems and methods for controlling environmental systems including a processor, a communication subsystem in electronic communication with the processor and adapted to enable electronic communication between the controller, a storage device and an environmental system, and context detection means in electronic communication with the processor, the context detection means adapted to automatically detect a change of context such that when the change of context is detected, comparing at least one setting with a corresponding current setting of the environmental system and if the setting does not match the current setting, adjusting the at least one environmental system to match the at least one setting of the at least one environmental system.

### FIELD

The present disclosure relates to wireless devices. More specifically, the present disclosure relates to electronic wireless controllers for controlling various systems in residential, commercial and industrial applications.

### BACKGROUND

There are a nearly unlimited number of separate systems in modern residential, commercial and industrial spaces that must be constantly monitored, controlled and adjusted depending on various environmental changes and user preferences. For example, a typical residential house includes a climate control system (perhaps including an air conditioner, furnace, radiators, hot water heater, dehumidifier/humidifier, fresh air intake, etc.), an electrical system (in turn providing electrical power to outlets, appliances and lighting fixtures) and optional yet common systems such as a security system, fire suppression system, lawn sprinkler system, among any number of other systems that are desired by the proprietor of the particular space in question.

These systems invariably require a centralized control unit (such as but not limited to an electric or mechanical thermostat, electrical control panel, etc.) to allow a user to operate the system and adjust its various working parameters.

With the advent of affordable and wireless electronic controllers, there has been a general desire to incorporate this wireless technology into these centralized various control units such that the user can remotely monitor and manage the system. As more and more traditional systems (such as climate control systems, security systems, etc.) become wirelessly enabled, there is also a general desire to amalgamate the various, separate control systems into a main control system.

Moreover, as more and more systems are amalgamated into a single, main control system more and more solutions are developed to automate, mechanize and control various aspects of the space using these emerging technologies. For example, door lock systems, window shades and internet-of-things (IOT) devices are all examples of emerging technologies for homes and businesses that have been automated in the interest of creating a “smart” home or business that can be remotely controlled and adjusted based on a user's preferences.

However, present amalgamated control systems are not adapted to automatically detect a change of environmental context, such as, but not limited to a particular user's presence when the user enters the space under consideration. Moreover, known solutions are not configured to automatically and predictively adjust the various environmental systems based on a detected change of environmental context and any available external data that can be obtained from any number of third-party sources.

Therefore, there is need for a centralized controller that is adapted to control a number of environmental systems based on a change of context and which can automatically and predictively adjust these systems based on a user's behavior and any available external data.

### BRIEF SUMMARY

It is contemplated that the present disclosure provides systems and methods for controlling a number of environmental systems based on a detected change of context and which can automatically and predictively adjust these systems based on the user's behavior and any available and relevant external data.

In at least one embodiment, it is contemplated that the present disclosure can provide a controller for controlling environmental systems having a processor, a communication subsystem in electronic communication with the processor and adapted to enable electronic communication between the controller, a storage device and at least one environmental system, the environmental system having a system processor and a system communication subsystem in electronic communication with the communication subsystem of the controller, and context detection means in electronic communication with the processor, the context detection means adapted to automatically detect a change of context, the change of context associated with at least one environmental setting, the at least one environmental setting stored with the storage device, comparing the at least one setting of the at least one environmental system with a corresponding at least one current setting of the at least one environmental system, and if the at least one setting of the at least one environmental system does not match the at least one current setting of the at least one environmental system, adjusting the at least one environmental system to match the at least one setting of the at least one environmental system.

In at least one embodiment, the present disclosure provides a method of controlling at least one environmental system including the steps of detecting, with context detection means in electronic communication with a processor, a change of context, the change of context associated with at least one environmental setting, the at least one environmental setting stored with a storage device, comparing, with the processor in electronic communication with the storage device and the at least one environmental system, the at least one setting of the at least one environmental system with a corresponding at least one current setting of the at least one environmental system, and if the at least one setting of the at least one environmental system does not match the at least one current setting of the at least one environmental system, adjusting, with the processor in electronic communication with the at least one environmental system, the at least one environmental system to match the at least one setting of the at least one environmental system.

### DESCRIPTION OF THE DRAWINGS

The present disclosure will be better understood in connection with the following FIGURES, in which:

FIG. 1 is an illustration of a suitable system for use in accordance with at least one embodiment of the present disclosure;

FIG. 2 is an illustration of a suitable controller for use in accordance with at least one embodiment of the present disclosure;

FIG. 3 is a diagram of a method for adjusting the setting of an environmental system based on a change of context in accordance with at least one embodiment of the present disclosure;

FIG. 4 is a diagram of a method for obtaining a user preference when the change of context is a detected user in accordance with at least one embodiment of the present disclosure; and

FIG. 5 is a diagram of a method for adjusting the setting of an environmental system based on external data in accordance with at least one embodiment of the present disclosure.

### DETAILED DESCRIPTION OF THE EMBODIMENTS

In at least one embodiment, the present disclosure provides a controller that is adapted to control an environmental system based on a detected change of context and a set of associated settings for the environmental system. Moreover, in some embodiments it is contemplated that the present disclosure can automatically and predictively adjust the setting of an environmental system based on a change in context such as a user's presence, the user's behavior and any available and relevant external data.

In the context of the present disclosure, a suitable “user device” includes any suitable computing device such as but not limited to a mobile device, smart phone, a tablet, laptop, desktop terminal, server terminal, and application service. A suitable user device will have suitable local memory, input means and display means and will have an electronic communication module that enables electronic communication with other devices, either hard wired or wirelessly, over a suitable electronic communication network, as will be discussed in further detail herein.

In the context of the present disclosure, a suitable “storage device” includes any suitable data storage device such as but not limited to a remotely located server device and a user device as discussed herein. A suitable storage device will have suitable volatile and non-volatile memory (such as but not limited to SDD/HDD disk, Network Attached Storage (NAS) memory and RAMDISK memory), read/write means and will have an electronic communication module that enables electronic communication with other devices, either hard wired or wirelessly, over a suitable electronic communication network.

In the context of the present disclosure, a suitable “electronic communication network” includes any local area network (LAN) or wide area network (WAN) that enables electronic communication between suitably connected devices as required by the end-user application.

As will be appreciated by the skilled person, a suitable user device will be in electronic communication with suitable storage device over a suitable electronic communication network as discussed herein. In some embodiments the user device has local data storage means and in other embodiments the user device additionally or alternatively will be in electronic communication with a remotely located storage device over an electronic communication network. As such, suitable data storage may be provided that can be located remotely (i.e. in the cloud and electronically accessed via typical wired or wireless communication protocols) or in a locally oriented server stored onsite (or in other words, on-premises data storage) or in local storage on the user device and electronically accessed by way of standard wired or wireless communication protocols, as required by the end user application of the present disclosure. It is further contemplated that all electronic communication discussed herein can be encrypted electronic communications or unencrypted electronic communications as required by the particular end user application of the present disclosure.

It will further be appreciated by the skilled person that in some embodiments a suitable user device can be adapted and configured to run a suitable Application Programming Interface (API) that is suitable for sending and receiving encrypted electronic communications and managing, editing, storing, and accessing digital files in accordance with the present disclosure. In other embodiments, embodiments of the present disclosure can be accessed by a suitable user device through a web browser having access to a suitable electronic communication network, such as the Internet or a local area network.

In the context of the present disclosure, a suitable “environmental system” can include, but is not limited to, home entertainment systems, home security systems, climate control systems, lighting systems, information technology systems, smart appliances, internet-of-things (IOT) devices and other hardware having wireless communication capabilities, leak and moisture detection systems, among any other suitable residential, commercial or industrial environmental systems that can be controlled remotely in an electronic manner. In many embodiments, a suitable environmental system will be in wireless communication with the present systems and apparatuses, while in other embodiments it is contemplated that a suitable environmental system can have a hardwired electronic connection with the present systems and apparatuses. It is contemplated that a suitable environmental system will have a processor and a communication subsystem that is adapted for electronic communication with the communication subsystem and the processor of the controller, as will be discussed in further detail herein.

It is contemplated that a suitable environmental system can include an application programming interface (API) that enables electronic communication between the communication subsystem of the controller and the environmental system. In some embodiments, it is further contemplated that the controller can run a suitable software adapter to ensure mutual intelligibility between the controller and environmental system. In some embodiments, it is contemplated that a suitable environmental system will require configuration in order to properly communicate with the communication subsystem of the controller.

In the context of the present disclosure, a suitable “setting”, “current setting”, “user preference” and/or “stored user preference” can collectively include any suitable environmental system setting that can be associated with a particular environmental system and a particular change of context and/or a particular user, without limitation. Moreover, it is contemplated that suitable settings and user preferences can be associated with ancillary data related to the change of context, the user, the environmental system and/or the setting itself, including but not limited to data such as: time of day, day of week, month, external temperature, weather forecast, etc.

In the context of the present disclosure, a suitable “environmental sensor” could be any suitable sensor adapted to measure a qualifiable or quantifiable environmental factor, including but not limited to a temperature sensor, a clock, a processor, a camera, a moisture/humidity sensor, a microphone, a speaker, a light intensity sensor and an infrared sensor, among any other suitable environmental sensor that will be readily appreciated by the skilled person.

In the context of the present disclosure, a suitable “input means” can include any suitable data input means including a touchscreen, a keyboard, at least one microphone, an electrically connected mobile device or wearable device, among other suitable data input means that permit a user to input data into the controller.

In the context of the present disclosure, a suitable “context detection means” can include any suitable detection means including at least one microphone, a clock, a processor at least one video or image camera and means for detecting an electronic signal from an electronic device (such as a user device as discussed herein). It is further contemplated that suitable context detection means will include various known machine learning techniques or identity detection algorithms for identifying a change of context, as discussed herein.

In the context of the present invention, a suitable “change of context” can include any suitable change of context that is related to at least one of the user, the environmental system, the surrounding environment and any suitable external data. For example, a change of context can include, but is not limited to, the detection of user presence or additional users, a change of time, a change of weather, a change of environmental condition, a calendar change, a voice command provided by a user, an electronic command sent from a user device and an input from an environmental sensor.

In the context of the present disclosure, a suitable “identifying characteristic” and a “stored user characteristic” can be any detectable characteristic of a user that can be obtained by the context detection means and subsequently used to sufficiently identify the user from any of a visual, aural, contextual or electronic perspective. For example, a suitable identifying characteristic can include but is not limited to, a user's height, a user's speech pattern, a user's voice timbre, a user's body shape, a user's facial structure, a user's mobile device signal, a particular time of day associated with the user, a particular location associated with the user.

In the context of the present disclosure, a suitable “user profile” can be a suitable digital file that is stored with the storage device and can include a number of stored user characteristics for identifying a user and a number of user preferences such that each of the stored user preferences are associated with an environmental system as discussed herein. In this way, it is contemplated that a user profile will include the necessary digital information to both identify a user and modify the settings of an environmental system based on that particular user's preferences.

In the context of the present disclosure, suitable “external data” can be any suitable external data or information that can be obtained from any third party provider, service or device, including but not limited to traffic information, weather information, user schedule information, or an electronic message containing relevant third party data or information sent from a third party device or service provider.

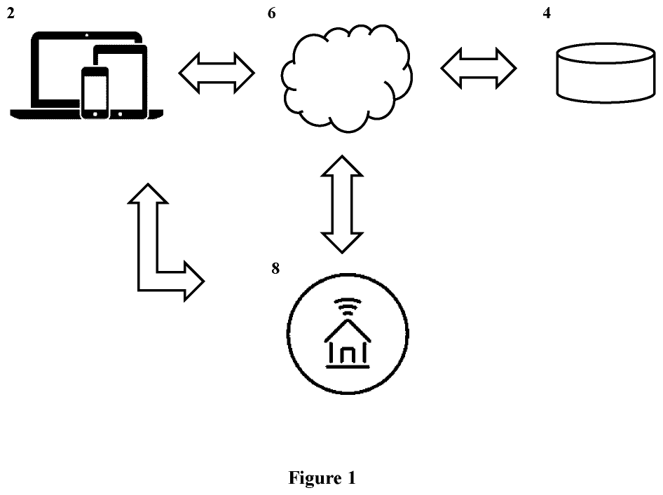

Turning to FIG. 1, at least one embodiment of a system for use in connection with the present disclosure is illustrated. In this embodiment, a user device 2, a storage device 4 and a controller 8 are in electronic communication with one another by way of an electronic communication network 6. In this embodiment user device 2 has visual display means and user interface means, as will be discussed herein. In this embodiment, storage device 6 is a remotely located server.

It is further contemplated that user device 2, storage device 4 and controller 8 are in electronic communication with each other through an electronic communication network 6 that is a wireless communication network operated through remote servers, also known as a cloud-based network, although other arrangements such as hard-wired local networks are also contemplated as discussed herein. Moreover, in this embodiment it is contemplated that user device 2 can also be in direct electronic communication with controller 8.

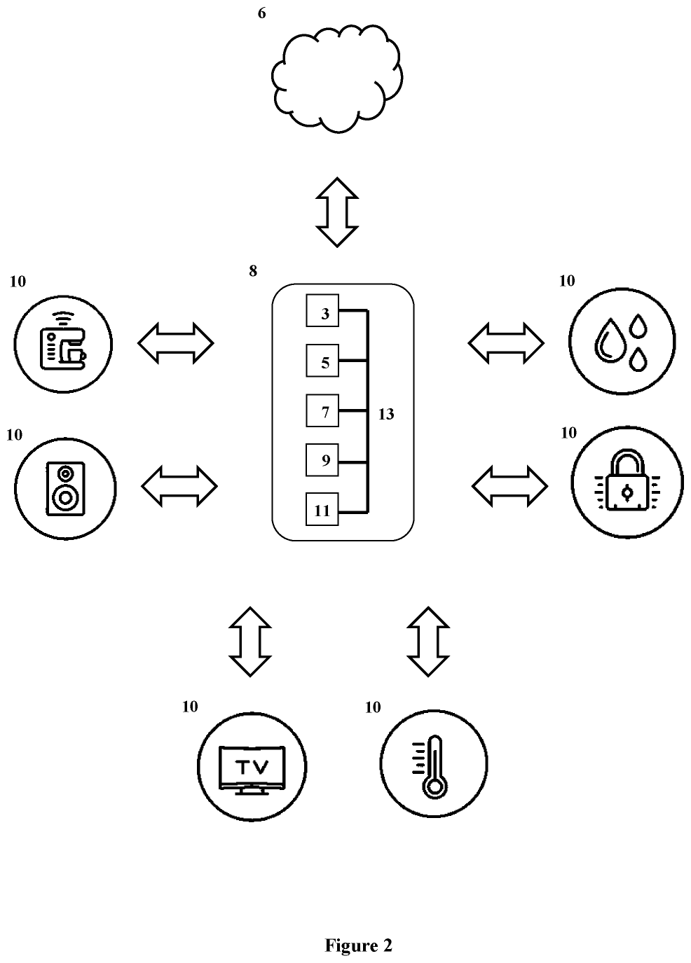

Turning to FIG. 2, at least one embodiment of controller 8 for use in connection with the present disclosure is illustrated. In this embodiment, controller 8 includes a processor 3, a communication subsystem 5 and local data storage 7, data input means 9, and user detection means 11 all of which are electronically connected by way of a bus 13. Communication subsystem 5 enables wireless electronic communication with electronic communication network 6 and various environmental systems 10, although other wired embodiments are also contemplated as discussed herein.

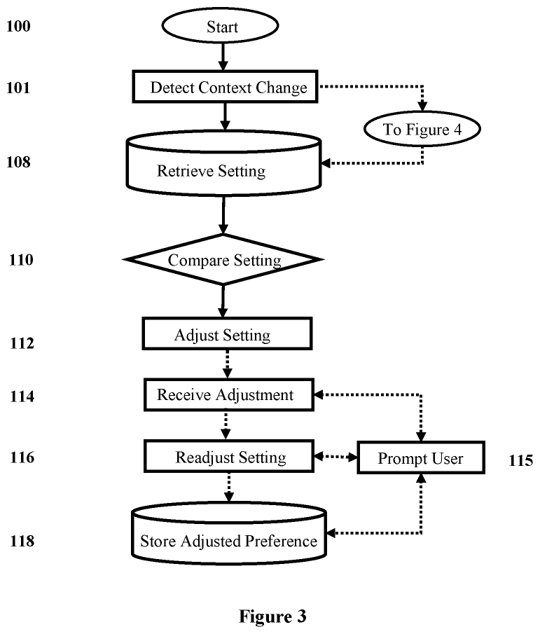

Turning to FIG. 3, at least one embodiment of a method for detecting a change of context and adjusting at least one setting of an environmental system is illustrated. In this embodiment, the method starts 100 and proceeds once a change of context is detected 101. It is contemplated that a detected change of context is associated with at least one setting of at least one environmental system, and that this associated at least one setting of at least one environmental system is stored on a storage device.

Once a change of context is detected 101, it is contemplated that at least one setting of at least one environmental system can be retrieved from the storage device 108. The at least one setting of at least one environmental system can be subsequently compared to a current setting of the at least one environmental system 110 by way of a processor of the controller in electronic communication with the storage device. Next, if it is determined that the at least one setting of at least one environmental system does not match the current setting of the at least one environmental system, the system processor can adjust the setting of the environmental system based on the user preference 112 to match the at least one setting of at least one environmental system.

Optionally, it is contemplated that the user may adjust a setting of the environmental system by way of the provided input means. It is contemplated that the controller can receive the adjustment to the setting of the environmental system 114 and send the adjustment to the system processor which can readjust the setting of the environmental system based on the adjustment to the user preference 116. It is further optionally contemplated that the adjustment to the setting of the environmental setting can be stored in connection with the user profile in the local storage of the storage device 118. In this way, it is contemplated that the user profile can be continuously updated based on a particular user's initial user preferences and subsequent adjustments to those user preferences.

Moreover, it is contemplated that any number of suitable and related external data can be stored in the user profile in connection with the user preference, as required by the particular end user application and as discussed in further detail herein.

It is further contemplated that a user prompt can be provided to the user 115 (by way of, for example, the input means of the controller and/or an electronically connected user device) after the user adjustment has been received by the controller from the user 114, the setting of the environmental system has been readjusted 116 or the adjusted preference has been stored in the local storage of the storage device 118. In this way, it is contemplated that the user can be notified of the change to the stored user preference, and the user can in turn confirm the change, cancel the change and/or confirm that the adjusted user preference has been stored in connection with the user profile on the storage device.

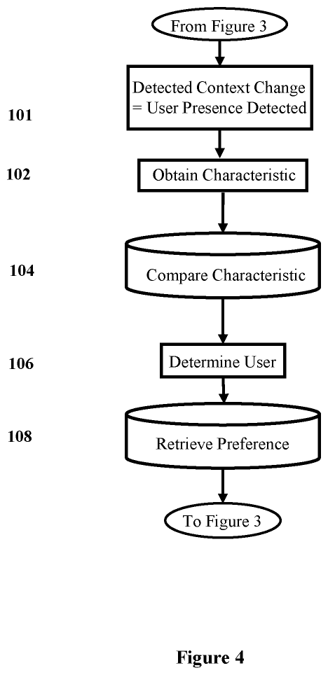

Turning to FIG. 4, in some embodiments it is contemplated that the change of context can be the detection of user presence 101. In these embodiments, once user presence is detected 101, it is contemplated that an identifying characteristic can be obtained from the detected user 102. Once the identifying characteristic is obtained 102, it is contemplated that the identifying characteristic can be compared against a stored user characteristic 104 that is electronically stored in a user profile that is associated with a user and stored with the storage device.

Next, it is contemplated that if the identifying characteristic sufficiently matches the stored user characteristic, the user can be successfully determined 106 and a user profile stored on the storage device can be accessed.

It is contemplated that a user profile includes at least one user characteristic relating to a user and at least one user preference that relates to a corresponding environmental system. In this way, once an identifying characteristic has been compared successfully matched to a user characteristic and the user has been effectively identified 106, and a user preference can be retrieved 108. As discussed herein, it is contemplated that the user preferences relates to or is associated with a corresponding environmental system. By way of a non-limiting example, a suitable user preference could be “TIME=11:00 AM, ROOM TEMPERATURE=21° C.” and the related environmental system could be a “Climate Control System”.

This user preference can be subsequently retrieved 108 and sent to a suitable system processor of the environmental system 110 by way of a system communication subsystem that is in electronic communication subsystem and processor of the controller. Next, the system processor can adjust the setting of the environmental system based on the user preference 112.

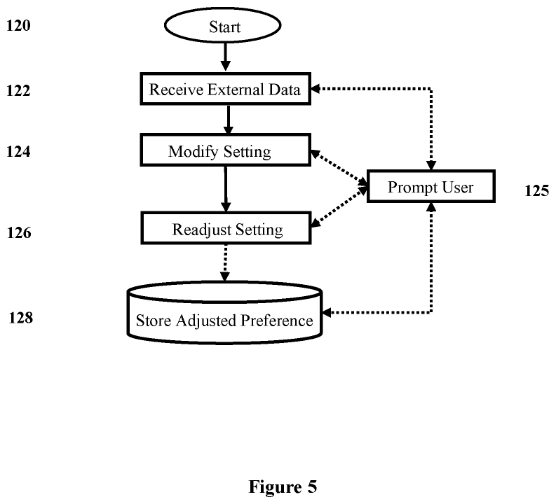

Turning to FIG. 5, an embodiment of a method for adjusting at least one setting of an environmental system based on external data is illustrated. In this embodiment, the method starts 120 and external data is received by the controller 122. It is contemplated that external data can be received from any suitable third party source, including but not limited to a weather or traffic information from a third party provider, scheduling information from a user's scheduling program or a third party provider, time or date information from any suitable source including a third party provider, environmental data from a connected device, among any other suitable external data that may be relevant to the particular end-user application.

Once the suitable external data is received 122, it is subsequently contemplated that the controller can receive the external data and modify a setting of an environmental system 124 and send the readjusted setting to the system processor which can readjust the setting of the environmental system based on the modification to the user preference 126. It is further optionally contemplated that the modification to the setting of the environmental system can be stored in connection with the user profile in the local storage of the storage device 128.

It is further contemplated that a user prompt can be provided to the user 125 (by way of, for example, the input means of the controller and/or an electronically connected user device) after the external data has been received by the controller 122, the modification has been made to the setting of the environmental system 124, the setting of the environmental system has been readjusted 126 or the adjusted preference has been stored in the local storage of the storage device 128. In this way, it is contemplated that the user can be notified of the receipt of the external data, the modification to the stored user preference, and the user can in turn confirm the change, cancel the change and/or confirm that the modified user preference has been stored in connection with the user profile on the storage device.

### Example 1: Turn on Lights

With reference again to FIG. 3, an embodiment of how the present method and system operate can be illustrated as follows:

The method starts 100 and a change of context is detected 101 when the time and date meet a predetermined criteria i.e. TIME=5 pm, DATE=December 5. As discussed herein, it is further contemplated that the change of context is associated with a setting of an environmental system. In this embodiment, it is contemplated that the at least setting of the environmental system is “Exterior Lights=ON” and the related environmental system is a “Home Lighting System”. It is contemplated that this setting can be retrieved 108, compared with the current setting of the environmental system 110 and subsequently electronically sent by the controller to the processor of the environmental system to adjust the setting of the environmental setting 112. As such, the home lighting system can adjust its current setting to match the setting, i.e. “Exterior Lights=ON” and the environmental system can be automatically operated to satisfy the adjusted setting 112.

It is subsequently contemplated that the user may use the input means of the controller to enter an adjustment to the setting of the environmental system 114 which in this embodiment would be adjusting “Exterior Lights=OFF”. In this embodiment, it is contemplated that the environmental system can be automatically operated to satisfy the readjusted setting 116 and a user prompt is optionally sent to the user' mobile device 115. In this embodiment, it is contemplated that the home lighting system can be operated to turn the exterior lights off.

Next, it is contemplated that the readjusted setting can be saved as a user preference in connection with the environmental system with the user profile on the storage device 118.

### Example 2: Temperature Adjustment

With reference again to FIGS. 3 and 4, another embodiment of how the present method and system operate can be illustrated as follows:

The method starts 100 when a user walks into a room in a house. This change of context is the detection of user presence 101 which is detected when the controller, equipped with user detection means that are a camera, obtains an identifying characteristic from the user 102 that in this embodiment is a visual facial identifying feature of the user. The identifying characteristic of the user is subsequently compared to a plurality of stored user characteristics that are stored in local storage of a storage device 104. It is contemplated that each stored user characteristic is associated with a stored user profile, and that each stored user profile is associated with a particular user. In this way, once the identifying characteristic of the user is matched to one of the stored user characteristics, the user can be determined 106.

As discussed herein, it is further contemplated that each user profile contains at least one user preference that is associated with an environmental system. In this embodiment, it is contemplated that the at least one user preference is “ROOM TEMPERATURE=21° C.” and the related environmental system is a “Climate Control System”. It is contemplated that this user preference can be retrieved 108 and subsequently electronically sent by the controller to the processor of the environmental system 110, which in this embodiment is an electronic thermostat that is in electronic communication with an air conditioning unit and a furnace. The electronic thermostat can adjust its internal setpoint to match the user preference, i.e. “ROOM TEMPERATURE=21° C.” and the environmental system can be automatically operated to satisfy the adjusted setting 112.

It is subsequently contemplated that the user may use the input means of the controller to enter an adjustment to the setting of the environmental system 114 which in this embodiment would be adjusting “ROOM TEMPERATURE=19° C.”. In this embodiment, it is contemplated that the environmental system can be automatically operated to satisfy the readjusted setting 116 and a user prompt is sent to the user' mobile device 115. In this embodiment, it is contemplated that the air conditioner can be operated to lower the temperature of the room.

Next, it is contemplated that the readjusted setting can be saved as a user preference in connection with the environmental system with the user profile on the storage device 118.

### Example 3: Adjust Alarm, Turn on Lights and Brew Coffee Based on Weather and Traffic Information

With reference to FIGS. 4 and 5, another embodiment of how the present method and system operate can be illustrated as follows:

The method starts 120 and external data is received from a third-party provider 122. In this embodiment, it is contemplated that the external data could be a weather report indicating upcoming snow and a traffic report indicating that traffic is quite heavy in the surrounding environment. Once this third party data is received 122 it is contemplated that this third party data is associated with at least one environmental system. In this embodiment, the environmental systems under consideration are a wireless alarm clock, a residential lighting system, and a wirelessly enabled coffee maker.

Once the external data is received 122, it is contemplated that at least one setting of the associated environmental system can be modified 124. In this case, the at least one setting is the same for all three environmental systems (i.e. START TIME=−30 minutes). In other words, the start time for all three environmental systems is set 30 minutes earlier.

Next, the readjusted setting can be sent from the controller to the processor of each environmental system and the readjusted setting can be applied to the environmental system 126. It is contemplated that the readjusted setting can be saved as a user preference in connection with the environmental system with the user profile on the storage device 128.

It is further contemplated that the user can be prompted 125 upon receipt of the relevant external data 122 to let the user know that the setting of the environmental systems (i.e. the alarm clock, the lights and the coffee maker) have been modified 124 (i.e. adjusted to start 30 minutes early) based on the received external data that is associated with these environmental systems.

The embodiments described herein are intended to be illustrative of the present compositions and methods and are not intended to limit the scope of the present disclosure. Various modifications and changes consistent with the description as a whole and which are readily apparent to the person of skill in the art are intended to be included. The appended claims should not be limited by the specific embodiments set forth in the examples but should be given the broadest interpretation consistent with the description as a whole.

1. A controller for controlling environmental systems comprising:
A processor;
A communication subsystem in electronic communication with the processor and adapted to enable electronic communication between the controller, a storage device and at least one environmental system, the environmental system having a system processor and a system communication subsystem in electronic communication with the communication subsystem of the controller; and
Context detection means in electronic communication with the processor, the context detection means adapted to automatically detect a change of context, the change of context associated with at least one environmental setting, the at least one environmental setting stored with the storage device;
Comparing the at least one setting of the at least one environmental system with a corresponding at least one current setting of the at least one environmental system; and
If the at least one setting of the at least one environmental system does not match the at least one current setting of the at least one environmental system,
Adjusting the at least one environmental system to match the at least one setting of the at least one environmental system.

2. The controller of claim 1, wherein when the change of context is the detection of user presence, the context detection means obtain an identifying characteristic from the user, the identifying characteristic is compared to at least one stored user characteristic stored with the storage device, each stored user characteristic associated with a user profile, the user profile containing at least one user preference relating to at least one setting of the at least one environmental system, retrieving the at least one user preference from the storage device, sending the at least one user preference to the at least one environmental system, adjusting at least one setting of the at least one environmental system to match the at least one user preference.

3. The controller of claim 1, further comprising data input means in electronic communication with the processor.

4. The controller of claim 1, further comprising local data storage in electronic communication with the processor.

5. The controller of claim 1, further comprising at least one software adapter, the at least one software adapter enabling electronic communication between the communication subsystem and the at least one environmental system.

6. The controller of claim 1, wherein the context detection means are selected from the group of: a processor, a video camera, a clock, an image camera, a microphone and means for detecting a signal associated with a user device.

7. The controller of claim 1, further comprising at least one environmental sensor.

8. A method of controlling at least one environmental system comprising the steps of:
Detecting, with context detection means in electronic communication with a processor, a change of context, the change of context associated with at least one environmental setting, the at least one environmental setting stored with a storage device;
Comparing, with the processor in electronic communication with the storage device and the at least one environmental system, the at least one setting of the at least one environmental system with a corresponding at least one current setting of the at least one environmental system; and
If the at least one setting of the at least one environmental system does not match the at least one current setting of the at least one environmental system,
Adjusting, with the processor in electronic communication with the at least one environmental system, the at least one environmental system to match the at least one setting of the at least one environmental system.

9. The method of claim 8, further comprising the steps of:
Obtaining, with the context detection means in electronic communication with the processor, an identifying characteristic from the user;
Comparing, with the processor in electronic communication with the storage device, the identifying characteristic to at least one stored user characteristic stored with the storage device in electronic communication with the controller, each stored user characteristic associated with a user profile, the user profile containing at least one user preference relating to at least one setting of the at least one environmental system;
Retrieving, with the processor in electronic communication with the storage device, the at least one user preference from the storage device;
Sending, with the processor in electronic communication with the storage device and the at least one environmental subsystem, the at least one user preference to the at least one environmental system; and
Adjusting, with the processor in electronic communication with the at least one environmental system, at least one setting of the at least one environmental system to match the at least one user preference.

10. The method of claim 8, further comprising the steps of:
Receiving, with the processor in electronic communication with the at least one environmental system, a user adjustment to the at least one setting of the at least one environmental system; and
Storing, with the processor in electronic communication with storage device, an adjusted user preference based on the user adjustment in the user profile on the storage device.

11. The controller of claim 8, further comprising the step of: sending, with the processor in electronic communication with a user device, a confirmation message to at least one of a user device and the input means of the controller.

12. The controller of claim 8 wherein at least one setting of the at least one environmental system is adjusted, with the processor in electronic communication with the environmental subsystem, based on at least one of external data associated with the at least one environmental system and at least one user preference associated with the at least one environmental system.
